(19) United States
(12) Patent Application Publication
(10) Pub. No.: US 2003/0030871 A1
(43) Pub. Date: Feb. 13, 2003

(54) Diversley routed fault tolerant optical node

(76) Inventor: Donald C. Dove, Kent, WA (US)

Correspondence Address: BLACK LOWE & GRAHAM, 816 SECOND AVE., SEATTLE, WA, 98104, US

(21) Appl. No.: 09/929,245

(22) Filed: Aug. 13, 2001

(51) Int. Cl. H04B 10/00; H04B 10/12; H04J 14/02

(52) U.S. Cl. 359/173; 359/125

(57) ABSTRACT

A hybrid fiber-coaxial network system with a fault tolerant multi-port optical node implementing a redundant diversely routed high-bandwidth single path. The system includes a plurality of fiber optic and coaxial paths. In the downstream path, the analog and digital data signals are sent from the head-end of the network to a subscriber of the data over the primary and secondary fiber paths of the network. A redundantly powered multi-port optical node, receives the signals. Electronic modules of the optical node convert the optical signals to RF signals and transmit the signals via a primary and secondary coaxial path to the subscriber. In the upstream path, the data signals are transmitted from the subscriber to the node over the coaxial data paths. Electronic modules of the optical node convert the RF signals to optical signals and transmit the signals over the primary and secondary fiber paths of the network.

### FIELD OF THE INVENTION

This invention relates to an improved hybrid fiber-coaxial system for transmitting and receiving analog and digital data signals of a data distribution network through a diversely routed bidirectional high bandwidth signal path from a fault-tolerant, multi-port optical node.

### BACKGROUND OF THE INVENTION

In recent years, the Cable Television (“CATV”) industry has been extending its traditional mandate by providing new television-based entertainment applications to an increasing number of subscribers. The new applications include, for example, broadband telecommunications, interactive multimedia, and video on demand (“VOD”). Because of the high bandwidth requirement for many of these new applications, the available bandwidth frequency range for both downstream and upstream transmissions is quickly exhausted. Additionally, as the variety of these applications and the number of subscribers continues to increase, the distribution systems for CATV plants must be continually modified and upgraded. This growth requires that the CATV equipment be rapidly and flexibly configurable as well as reliable. These requirements, in turn, have necessitated changes in the implementation of distribution systems from all-coaxial tree-and-branch architecture to systems that incorporate fiber optical networks of optical nodes in conjunction with multiple data signal paths, incorporating to various degrees the use of redundant components in the distribution plant to improve system reliability.

For example, U.S. Pat. No. 6,161,011 discloses a passive cable network system that includes a first and second fiber optic link to implement redundancy. Each fiber optic link includes at least one fiber cable coupled to an optical node and a coaxial distribution plant having a single coaxial distribution line and a plurality of amplifiers. The architecture relies on a wavelength division multiplexer (“WDM”) for eventual radio frequency conversion and output to a directional coupler. Reverse path (upstream) transmission is accomplished likewise over dual fibers. However, the system fails to incorporate or provide for system fault tolerance past the optical node.

In another example, U.S. Pat. No. 6,147,786 discloses a hybrid, bi-directional, analog/digital WDM access network with mini-digital optical nodes. The invention discloses a network that contains a hybrid of analog and digital signals on different wavelengths in one fiber originating from one head-end. The system relies on the implementation of a mini-optical node in a distribution system to increase available system bandwidth in both downstream and upstream transmissions. The node brings the fiber closer to the users and, as a result, strives to increase the spectrum available for downstream and upstream transmissions. However, the system fails to incorporate system fault tolerance past the optical node. Furthermore, it is well known in the art that mini-optical nodes suffer from higher thermal stress than comparably equipped standard size node enclosures. Because of the lack of incorporated system fault tolerance capabilities (for example, redundant power supplies), the distribution system is susceptible to cluster failure.

In still yet another example, U.S. Pat. No. 6,049,405 discloses the use of fiber redundancy over a pair of fiber deployed for downstream and upstream transmissions in an optical network. The fiber pair is geographically distinct and is activated if any of the ordinary fiber's transmissions are interrupted. More specifically, the patent teaches a system that deploys optical switching devices along with three transmitters and three receivers in each node along the bidirectional transmission path of dual fibers. When a transmission in either the forward path or reverse path is interrupted, a logical switching scheme is implemented to continue the transmissions along the paths. While fiber path redundancy is attempted through the implementation of a pair of fibers in the distribution system, once again the system fails to incorporate system fault tolerance past the optical node.

Accordingly, there remains a need for a hybrid fiber-coaxial network data distribution system with a multi-port optical node that implements a diversely routed high-bandwidth single path with redundancy in fiber and coaxial paths and in the optical node.

### SUMMARY OF THE INVENTION

The present invention addresses inherent problems with maximizing the bandwidth and redundancy of an optical node and the node feeder plants, and presents the solution in a fault tolerant multi-port optical node that deploys a diversely routed high bandwidth signal path.

In accordance with this invention, a plurality of fiber optical and coaxial paths are connected to a data distribution network. The data distribution network includes the distribution of the data from a head-end of the data network to a subscriber (downstream) of the data and back from the subscriber of the data to the head-end (upstream). The plurality of fiber optical and coaxial paths are further coupled to a multi-port optical node, which node includes a plurality of electronic modules. The electronic modules are system components of the node that control the electronic aspects of the optical node. The optical node receives the data of the distribution network and converts the data signal downstream in analog form and upstream in optical form.

In another aspect of the invention, the optical node is comprised of control interfaces for routing of the data of the distribution network over an optical and RF electronic module of the optical node. Additionally, the optical node has an interface for the routing of power from the primary or secondary power grid of the optical node to a plurality of electronic modules that comprise the optical node

In another aspect of the invention, the optical node is comprised of a plurality of electronic optical receiver modules. The receiver modules receive information-modulated light from one or more optical fibers of the distribution network and convert that information into an electrical signal for distribution over the network. The optical receiver modules include one or more modules for receiving digital data over the optical fiber and one or more modules for receiving either analog or digital data over the optical fiber of the distribution network.

In another aspect of the invention, the optical node comprises a plurality of optical transmitter modules. The transmitter modules convert electrical signals that originate primarily from the subscriber of the data services to information-modulated optical signals that are transported by optical fiber of the distribution network to a central location of the head-end data service provider. The optical transmitter modules include one or more modules for transmitting digital data over the optical fiber and one or more modules for transmitting either analog or digital data over the optical fiber of the distribution network.

In another aspect of the invention, the optical node comprises a plurality of RF output modules. The RF output modules comprise the RF interface to one or more cables of a coaxial cable plant of the data distribution network. The RF output modules include one or more modules for transmitting digital data over the coaxial cable and one or more modules for transmitting either analog or digital data over the coaxial cables of the distribution network.

In another aspect of the invention, the optical node comprises at least one primary and one secondary power supply module, which power supply modules receive AC/DC electrical power for the optical node from a primary or secondary grid cable. The AC/DC power is converted to DC at regulated levels for distribution to any of the optical receivers, optical transmitters, and RF output modules deployed in the optical node.

In still yet another aspect of the invention, power supply modules can be added as needed to the optical node, including adding power modules to the node when the node has been activated on the distribution network.

In accordance with still further aspects of the invention, the distribution network comprises one or more coaxial cable paths from the optical node to a subscriber drop. The subscriber drop is the subscriber tap into the data of the distribution network. The one or more coaxial paths include a primary and secondary path from the optical node to the subscriber drop.

In accordance with still further aspects of the invention, the primary and secondary coaxial cable paths are diplexed together at a digital reception point. The primary cable's signals are combined with the secondary cable's signals to transmit to the subscriber home a digital spectrum from 5 MHz to the upper edge of the frequency band.

In accordance with yet other aspects of the invention, one or more power packs provide redundant power to the one or more coaxial paths.

In accordance with further aspects of the invention, the bandwidth of a digital downstream transmission is in the range of 220 MHz to 870 MHz; the bandwidth of an analog downstream transmission is in the range of 55 MHz to 550 MHz; and the bandwidth of a digital upstream transmission is in the range of 5 MHz to 220 MHz.

### BRIEF DESCRIPTION OF THE DRAWINGS

The preferred and alternative embodiments of the present invention are described in detail below with reference to the following drawings.

FIG. 1 is illustrative of a distribution system for a diversely routed fault-tolerant high bandwidth signal path according to an embodiment of the present invention;

FIG. 2 is an exploded view of the multi-port optical node with redundant features shown in FIG. 1;

FIG. 3 is a block diagram illustrating the downstream and upstream data signal paths according to an embodiment of the present invention;

FIG. 4 is a flow chart illustrating the operation of a digital downstream data path according to an embodiment of the present invention; and

FIG. 5 is a flow chart illustrating the operation of an upstream digital data path according to an embodiment of the present invention.

### DETAILED DESCRIPTION OF THE PREFERRED EMBODIMENT

The present invention comprises a system integrated into a data distribution network for transmitting and receiving analog and digital data through a diversely-routed bi-directional high bandwidth signal path from a fault-tolerant, multi-port optical node.

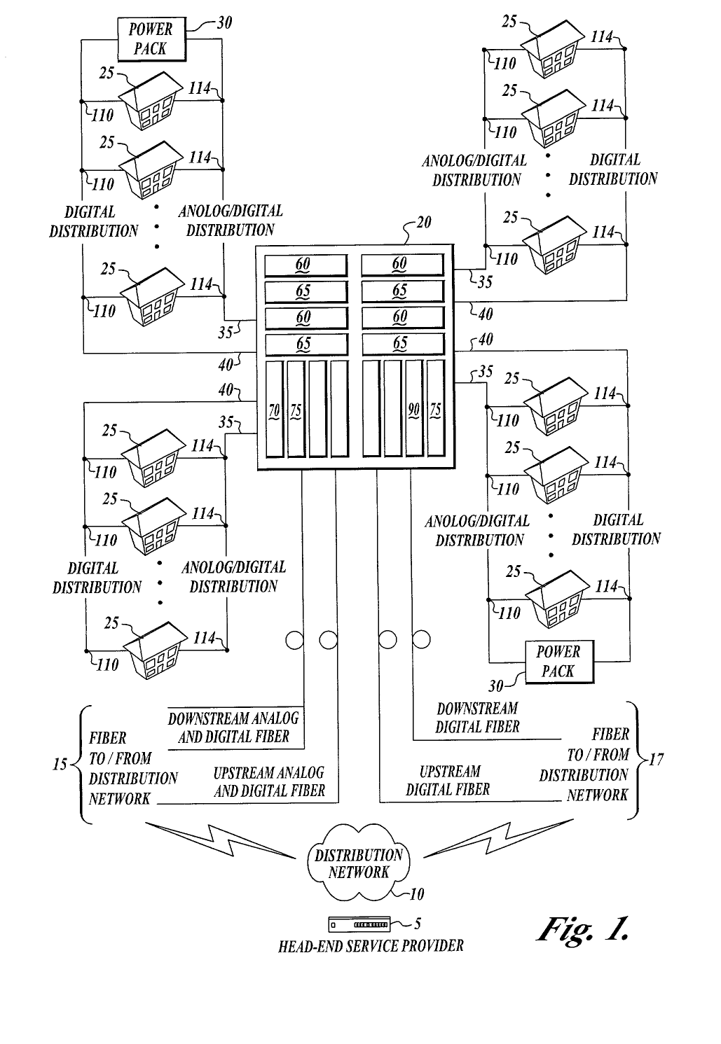

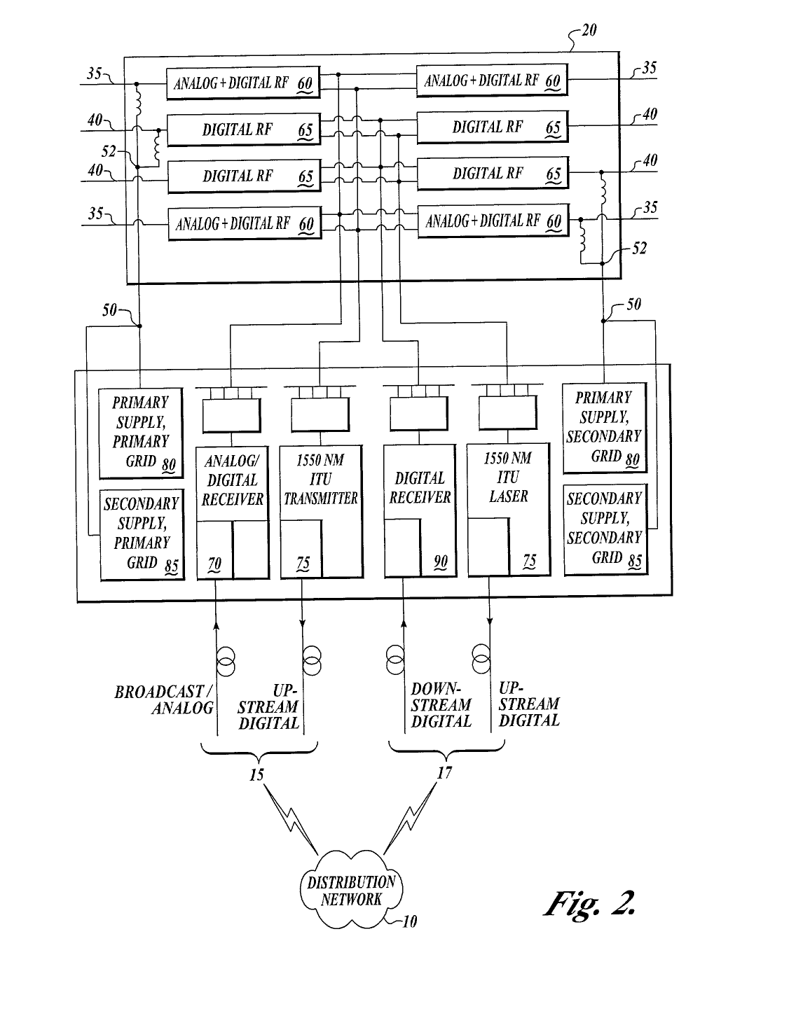

FIG. 1 illustrates a data distribution network for a fault-tolerant diversely routed high-bandwidth signal path to and from an optical node according to an embodiment of the present invention. A head-end service provider 5 is a source of digital and analog data signals sent as optical signals that are distributed over a distribution network 10. The distribution network includes a primary 15 and a secondary 17 fiber path, coupled to one or more optical nodes 20. The optical node is further described in FIG. 2 below. Fiber paths 15 and 17 distribute the data of distribution network 10 from head-end 5 to one or more subscribers 25, as well as the data from subscribers 25 to head-end 5. The network further includes primary 35 and secondary 40 coaxial cable paths coupled to optical nodes 20 for transmission of data signals of distribution network 10 from the head-end to the subscribers and from the subscribers to the head-end. The subscribers tap into the data signals at coaxial cable drops 110-114, which in turn are coupled to coaxial cable paths 35 and 40 of the network. Optical node 20 includes one or more electronic modules (further referenced in FIG. 2 below) 70, 75 and 90, for receiving and transmitting the data signals from fiber paths 15 and 17 to coaxial paths 35 and 40. Optical node 20 further includes one or more electronic modules 60 and 65 for receiving, converting and transmitting the RF data signals of distribution network 10. Coaxial cable paths 35 and 40 are coupled to one or more power packs 30 to provide primary and secondary power to the coaxial paths. The data received on the subscriber equipment typically consists of television programming, but may include other data including Internet services, telephone services, and specific subscription services referred to as narrowcast services.

FIG. 2 is an exploded view of the preferred embodiment of the multi-port optical node with redundancy shown in FIG. 1 according to an embodiment of the present invention. An optical node 20 is coupled to one or more fiber paths 15 and 17 via optical reception ports (not shown) of a distribution network, as referenced in FIG. 1. The optical node comprises one or more electronic modules, including one or more analog (“RF”) output modules 60 and 65, an analog/digital receiver module 70, and a digital receiver module 90. Analog/digital receiver module 70 and digital receiver module 90 are used to receive the optical signal of fiber cable paths 15 and 17, as well as to transmit the signal to analog RF output modules 60 and 65. The data signal is converted and output by the RF output modules 60 and 65 through one or more RF output ports (not shown) coupled to one or more coaxial cable paths 35 and 40, as further shown in FIG. 1. Redundant power is provided to optical node 20 through primary and secondary power supply grid modules 80 and 85. Primary and secondary power supply grid modules 80 and 85, which interface via nodes 50, provide redundant module power through taps 52. While the preferred embodiment is described with a fixed plurality of ports for each of the sides of the optical node for the incoming and outgoing of data signals, the number of ports is flexible to meet the installation requirements of a particular optical node.

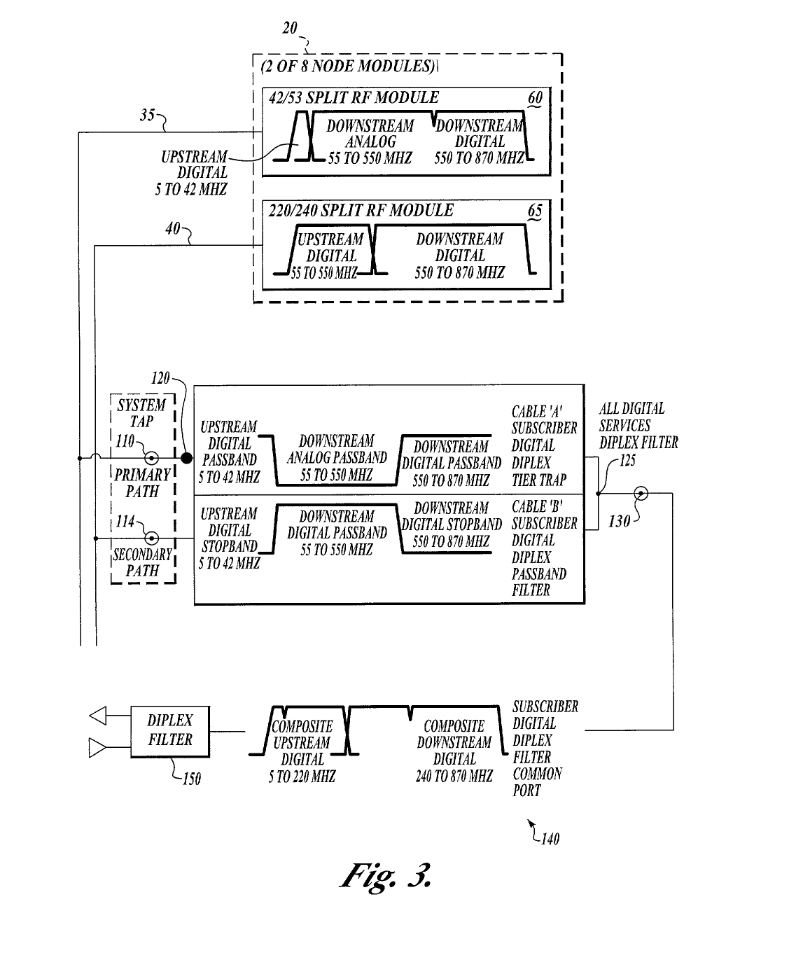

FIG. 3 is a block diagram illustrative of a diversely routed high bandwidth signal path according to an embodiment of the present invention. As further referenced in FIGS. 1 and 2, one or more fiber paths 15 and 17 carry a data signal transmitted from a head-end service provider 5 to a downstream optical node 20 of a distribution network 10. The data signals of fiber path 15 are received by analog/digital receiver 70 and data signals of fiber path 17 are received by digital receiver 90 of the optical node 20. RF output module 60 of optical node 20 receives the signals as RF (detected light) signals from the analog/digital receiver 70. RF output module 65 receives the signals as RF (detected light) signals from digital receiver 90. The analog/digital receiver module converts the light signals using, for example, a photodiode, to RF signals. The analog/digital RF output module transmits the signal through downstream primary coaxial data signal path 35 in an analog range of 55 to 550 MHz and in a digital range of 550 to 870 MHz. The digital RF output module transmits the RF signals through downstream secondary coaxial data signal path 40 in the digital signal range of 240 to 870 MHz. The downstream RF signals are then passed via primary coaxial cable path 35 and secondary coaxial cable path 40 to a primary system tap 110 and a secondary system tap 114 of distribution network 10. The system tap is the point of entry for providing the subscriber services of head-end 5 provider to subscribers 25 home. A splitter 120 provides segmentation of the analog signals on the downstream primary coaxial cable path 35 for the transmission of analog data signals to subscriber 25. Primary coaxial cable path 35 to a subscriber 25 provides a data signal path for a downstream analog stopband of 55 to 550 MHz and downstream digital passband of 550 to 870 MHz. Secondary coaxial cable path 40 to a subscriber 25 provides the data path for a downstream digital passband of 55 to 550 MHz and downstream digital stopband of 550 to 870 MHz. Primary cable path 35 provides the analog transmission band and is trapped out via a diplex filter 125 and combined with secondary cable path 40, which is then band passed in the frequency domain of the primary cable's analog programming and dropped at 130 to subscriber 25 for subsequent viewing by the subscriber. At a subscriber 25 home, an all-digital subscriber terminal device contains a 220/240 MHz diplex filter split 150 to provide separation of the downstream and upstream path in the range of 5 to 220 MHz in the upstream path and 240 MHz to 870 MHz in the downstream path 140.

Data sent from the subscriber 25 to head-end 5 is transmitted on the upstream data signal path over primary coaxial cable path 35 and secondary coaxial cable path 40 to one or more RF output modules 60, 65. The RF output modules send the signals to one or more transmitters 75 of optical node 20. The transmitters provide the RF to optical conversion to send the signals via primary 15 or secondary 17 fiber signal paths, further shown in FIG. 1. Primary coaxial cable path 35 from a subscriber 25 provides a data signal path for an upstream digital passband of 5 to 42 MHz. Secondary coaxial cable path 40 from a subscriber 25 provides a data signal path for an upstream digital stopband of 5 to 42 MHz. An advantage of the invention is that all bandwidth allocated to analog transmissions on primary coaxial cable path 35 can be re-allocated for digital transmission on secondary coaxial cable path 40. This provides an upstream data path in the 55 to 220 MHZ range over secondary coaxial cable path 40.

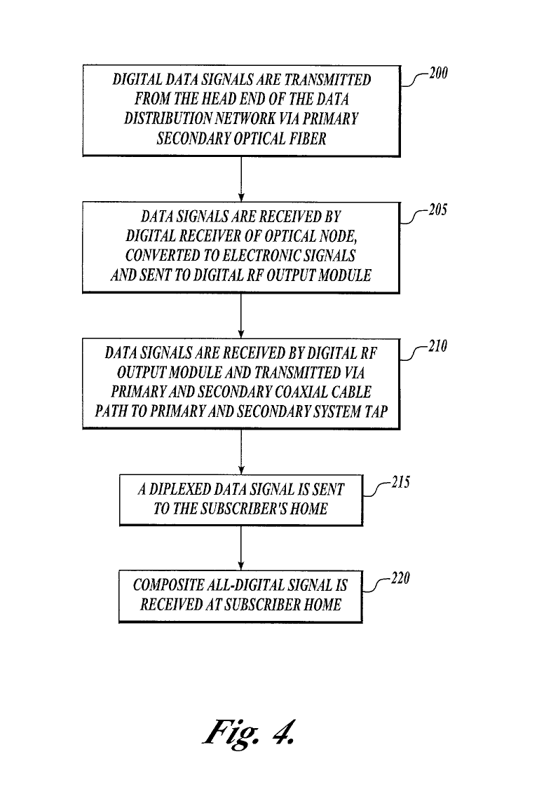

FIG. 4 is a flowchart showing the process of a digital data signal being sent downstream via an all digital path from head-end 5 of distribution network 20 to a subscriber 25 (see also FIGS. 1-3). At block 200, digital data signals are transmitted from head-end 5 to optical node 20 via primary 15 and secondary fiber path 17. At block 205, digital receiver 90 of optical node 20 receives the data signals, converts the signals to electronic signals and forwards the signal to digital RF output module 40. At block 210, the digital output module receives the RF signals as further referenced in FIG. 2. The data signals are transmitted via primary 35 and secondary coaxial cable path 40 downstream to be tapped out at primary 112 secondary system tap 114. At block 215, unused analog bandwidth from primary coaxial cable path 35 is allocated to secondary coaxial cable path 40, diplexed together at digital reception point 130, and sent to a subscriber 25 at block 215. The composite all digital signal is received by digital compatible equipment, for example, a digital set top box, at subscriber 25, in the range of 5 to 870 MHZ.

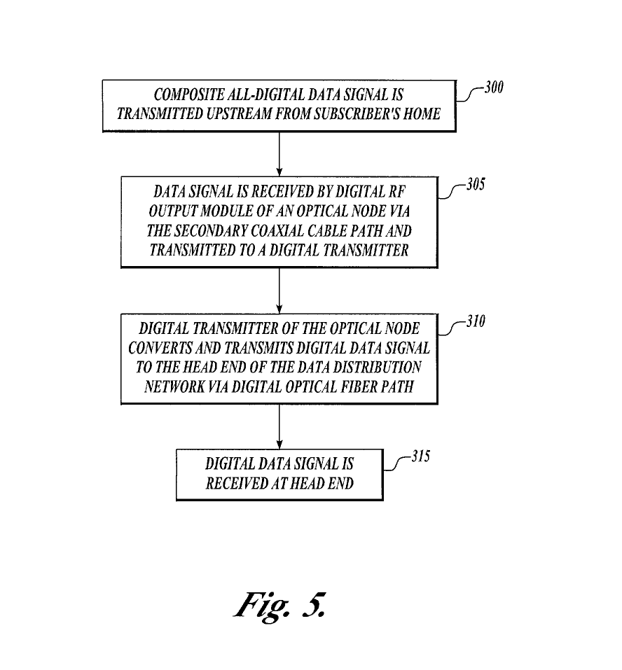

FIG. 5 is a flowchart showing the process of an all-digital data signal sent upstream from a subscriber 25 to head-end 5 of distribution network 10, and is further referenced in FIGS. 1-3. At block 300, a composite all digital signal is transmitted from a subscriber 25 in the range of 5 to 220 MHZ from compatible equipment, for example, a digital set top box. At block 305, the data signal is received by digital RF output module 65 of optical node 20 via secondary coaxial cable path 40. The signal is further transmitted by the output module to digital transmitter 75 of the optical node. At block 310, digital transmitter 75 converts the received RF signal to an optical signal and transmits the data signal to head-end 5 via primary or secondary fiber path 15, 17 of the distribution network. At block 315, the digital data signal is received at the head-end 5.

Another advantage of the invention is that it allows the diplexing of the primary and secondary data signal paths. This provides the system operator of the head-end with a composite contiguous digital spectrum for subscriber services from 5 MHZ to the upper edge of the frequency band (fₕᵢ) for both upstream and downstream data signals. Another advantage of the primary and secondary coaxial cable paths 35, 40 is their redundant nature: a fault condition on one of the paths only means a reduction in overall available bandwidth and not a total loss of all the bandwidth of the digital service.

While the flowchart referred to in FIGS. 4 and 5 illustrates a particular embodiment of downstream and upstream transmission operations, those skilled in the art will recognize that the events may occur in any sequence without departing from the scope of the present invention.

While the preferred embodiment of the invention has been illustrated and described, as noted above, many changes can be made without departing from the spirit and scope of the invention. For example, head-end service provider 5 may transmit the full spectrum of analog data signals (55 to 550 MHz) downstream via primary fiber data path 15 while still offering the full digital downstream and upstream spectra. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A diversely routed high bandwidth hybrid fiber-analog communication system comprising:
at least one fiber optic path connected to a data signal distribution network for bi-directional transmission of data signals;
at least one coaxial path connected to a data signal distribution network for bi-directional transmission of data signals; and
an optical node with one or more electronic modules coupled to the fiber optic and coaxial paths.

2. The system of claim 1, wherein the optical node receives the data signals of the fiber optic path.

3. The system of claim 2, wherein the optical node converts the data signals of the fiber optic path to analog signals and transmits the data signals on the coaxial path.

4. The system of claim 1, wherein the optical node receives the data signals of the coaxial path.

5. The system of claim 4, wherein the optical node converts the data signals of the coaxial paths to optical signals and transmits the data signals on the fiber optic paths.

6. The system of claim 1, further comprising at least one electronic power supply module coupled to the optical node for providing redundant power to one or more electronic modules.

7. The system of claim 1, further comprising at least one power supply pack coupled to the optical node for providing redundant power to the optical node.

8. A diversely routed high bandwidth hybrid fiber-analog communication system comprising:
a plurality of fiber optic paths connected to a data signal distribution network for a bi-directional transmission of data signals;
a plurality of coaxial paths connected to a data signal distribution network for a bi-directional transmission of data signals;
an optical node with a plurality of electronic modules coupled to the fiber optic and coaxial paths for:
receiving the data signals of said plurality of fiber optic paths;
converting the data signals to analog signals and transmitting the data signals on the plurality of coaxial paths;
receiving the data signals of the plurality of coaxial paths; and
converting the data signals to optical signals and transmitting the data signals on the plurality of fiber optic paths;
a plurality of power supply electronic modules coupled to the optical node for providing redundant power to the plurality of electronic modules; and
a plurality of power supply packs coupled to the optical node for providing redundant power to the optical node.

9. The system of claim 8, wherein the plurality of fiber optic paths includes a primary fiber optic path.

10. The system of claim 8, wherein the plurality of fiber optic paths includes a secondary fiber optic path.

11. The system of claim 8, wherein the plurality of coaxial cable paths includes a primary coaxial cable path.

12. The system of claim 8, wherein the plurality of coaxial cable paths includes a secondary coaxial cable path.

13. The system of claim 9, wherein the primary fiber optic path is for the downstream transmission of analog and digital signals.

14. The system of claim 9, wherein the primary fiber optic path is for the upstream transmission of analog and digital signals.

15. The system of claim 10, wherein the secondary fiber optic path is for the downstream transmission of digital signals.

16. The system of claim 10, wherein the secondary fiber optic path is for the upstream transmission of digital signals.

17. The system of claim 11, wherein the primary coaxial path is for the downstream transmission of analog and digital signals.

18. The system of claim 11, wherein the primary coaxial path is for the upstream transmission of analog and digital signals.

19. The system of claim 11, wherein the secondary coaxial optic path is for the downstream transmission of digital signals.

20. The system of claim 11, wherein the secondary coaxial path is for the upstream transmission of digital signals.

21. The system of claim 8, wherein the downstream transmission data signals are in the range of 5 MHz to 870 MHz.

22. The system of claim 8, wherein the upstream transmission data signals are in the range of 5 MHz to 220 MHz.

23. The system of claim 8, wherein the data signal is received by a subscriber of the data distribution network.

24. The system of claim 23, wherein a diplexer for separating or combining the data signals diplexes the data signal received by a subscriber.

25. The system of claim 8, wherein the data signal is transmitted by a subscriber of the data distribution network.

26. The system of claim 25, wherein a diplexer for separating or combining the data signals diplexes the data signal transmitted by the subscriber.

27. A method of transmitting bidirectional data signals between a network head-end and at least one subscriber, the data signals including both analog and digital data, comprising:
transmitting data signals on at least one optical or coaxial data signal path from the head-end or one or more subscriber;
receiving the data signals at an optical node having at least one module for processing the data signals through the optical node, which module is coupled to the data signal path;
converting the data signals to optical or analog signals; and
transmitting the converted optical or analog signals to the head-end or to the one or more subscribers via the one or more optical or coaxial data signal paths.
